(19) United States
(12) Patent Application Publication
(10) Pub. No.: US 2008/0179330 A1
(43) Pub. Date: Jul. 31, 2008

(54) Trash containment system

(76) Inventors: Kerry G. Brooks, Junction City, OR (US); Dan Wilkins, Eugene, OR (US)

Correspondence Address: MEREK, BLACKMON & VOORHEES, LLC, 673 S. WASHINGTON ST., ALEXANDRIA, WV, 22314, US

(21) Appl. No.: 12/010,759

(22) Filed: Jan. 29, 2008

Related U.S. Application Data
(63) Continuation-in-part of application No. 11/699,011, filed on Jan. 29, 2007.

(51) Int. Cl. B65D 25/00; B65D 25/14; B65D 81/24; B23P 19/04; B65D 30/02

(52) U.S. Cl. 220/495.08; 220/495.07; 206/205; 383/109; 29/700

(57) ABSTRACT

A trash containment system is disclosed comprising a secondary containment liner having an absorbent section in the bottom. The secondary containment liner is generally placed within a trash bag container, and receives a single-use trash bag that may differ from the secondary containment liner in one or more aspects. The secondary containment liner can reduce liquid leakage and reduce malodors released from the trash.

This application claims priority to U.S. patent application Ser. No. 11/699,011, “Trash receptacle Liner System and Method” by Kerry Brooks and Dan Wilkins, filed Jan. 29, 2007.

### FIELD OF THE INVENTION

This invention relates to systems for containing trash in lined trash containers and systems for reducing odors or leakage from trash, as well as methods of manufacture and use.

### BACKGROUND

Trash containers, typically lined with trash bags, are a ubiquitous means for dealing with waste in public places and numerous other settings. In spite of the many advances in waste management systems, fundamental problems remain. For example, liquid waste in bags may leak out, leaving undesirable waste at the bottom of a trash container or elsewhere. Overloaded bags may also result in spillage from overflowing waste or from breaks or leaks in the bag, resulting in waste material inside trash containers or on the floor away from the containers when the bags are removed to a dumpster or other location. Liquid on the floor that has leaked from a trash bag may result in slipping or other accidents, and waste of any kind that escapes or spills from trash bags may result in insect infestations or the growth of unwanted bacteria or other microbes, and may attract unwanted pests such as rodents. The malodors and unsightly appearance of spilled waste can also have a negative impact on a business or other operation.

While previous attempts have been made to add odor-absorbing materials to trash cans, dumpsters, trash bags, and the like, previous solutions have been inadequate. Many past attempts, for example, fail to provide adequate solutions for reducing the problem of leakage from bags. Trash bags in fast food outlets and other places where beverages are consumed can become filled with significant quantities of liquid that may leak from the trash bag. Employees carrying such bags to the dumpster may leave behind liquid waste in the trash can or bin and a trail of liquid waste between the can or bin and the dumpster where the bag is disposed.

Leakage can be reduced by using heavier, more expensive bags or by using two or more bags (“double bagging”), but this approach is unnecessarily expensive when high liquid loads are not present. The liquid content of trash bags can be highly variable, so a single bag that can prevent leakage for unusually high liquid loads may represent expensive overkill for the typical less wet loads encountered. There is a previously unaddressed need to provide a flexible solution for containing liquid waste that avoid wasteful and unnecessarily expensive approaches for typical loads, but can provide backup containment of liquid during times of unusually high load.

The need for odor control also varies significantly over time as does the need for liquid containment in trash bags. In the garbage disposed in a typical home, for example, the garbage may generally be relatively free of highly odorous materials and may not require the use of odor inhibiting agents. Nevertheless, occasional loads may contain malodorous materials for which odor control is highly desirable. There is a need for odor containment systems for garbage systems that avoids wasteful or unnecessary disposing of odor absorbent or odor neutralizing material when it is not needed, but provides for odor absorbent or neutralizing means when an unusually malodorous load is encountered, or when there is a risk of leakage of malodorous material.

One or more of the heretofore mentioned needs may be addressed in full or in part by the invention hereafter described, and while some embodiments may satisfy multiple such needs to various degrees, it is to be understood that embodiments within the scope of the present invention need not satisfy all needs herein described or deliver all the benefits or objectives that may be ascribed, directly or indirectly, to various embodiments of the invention.

### SUMMARY

An improved trash containment system has been developed comprising a single-use trash bag placed within a disposable secondary containment liner at least partially contained within a trash bag container, wherein the secondary containment liner comprises absorbent material capable of inhibiting undesirable odors and absorbing liquid waste. Inhibition of odors can include any known mechanism such as absorbing malodors, chemically altering materials that may generate malodors, direct reaction of malodorous chemicals to form less malodorous reactants, inhibiting the growth of bacteria or other microorganisms that generate malodors, or promoting the growth of microorganisms that directly or indirectly inhibit malodors, etc. The absorbent material in the secondary containment liner is typically located at the bottom of the interior thereof, but may be present on the side, near the top, or in multiple locations on the liner.

In some embodiments of the invention, a packaged product is provided comprising at least one secondary containment liner having attached absorbent material therein and, for each secondary containment liner, one or more single-use trash bags for use with the at least one secondary containment liner, wherein the secondary containment liner, particularly the flexible film material used in construction of the secondary containment liner, is physically distinguishable from the single-use trash bag (particularly the flexible film material used in its construction) by at least one of color, printed indicia, length, material characteristics such as texture, and opacity. Such distinguishing features between the secondary containment liner and the single-use trash bag generally relate to differences in appearance, but differences in tactile properties or other properties may also be present or relied on, such as texture, thickness, stiffness, basis weight, tensile strength, etc. The secondary containment liner may also or alternatively be distinguished from the single-use trash bag by the presence of attachment means for attaching the secondary containment liner to the durable trash bag container. When the secondary containment liner is attached to the trash bag container, the single-use trash bag therein will generally be unattached, or at least attached to a different portion of the trash bag container to facilitate easy removal of the single-use trash bag without simultaneous removal of the secondary containment liner. The use of color to distinguish the secondary containment liner from conventional single-use trash bags can need not require that the entire secondary containment liner be of a different color. For example, a fluorescent pink or yellow band may be attached to the end of the secondary containment liner to mark it and help reduce the risk of premature discarding.

As used herein, the term “single-use trash bags” refers generally to disposable trash bags such as conventional trash bags that can be discarded with their contents, but it is understood that under some circumstance users may wish to empty the contents of the single-use trash bag and reuse the bag when it has not been damaged, soiled, or wetted, for example. Thus, there is no requirement that a single-use trash bag only be used once.

The single-use trash bag can be removed and replaced without removing and disposing of the secondary containment liner, but both the single-use trash bag and the secondary containment liner can be removed together when desired (e.g., by grasping the mouth of the secondary containment liner and removing it, thereby bringing the enclosed single-use trash bag along). For example, when the contents of the single-use trash bag are high in liquid content and likely to leak or contain malodorous material, the single-use trash bag and the secondary containment liner can be grasped together and removed in one operation, wherein the secondary containment liner serves to capture fluid that may be leaking from the single-use trash bag and to absorb odor that may be escaping from the single-use trash bag. In this manner, a flexible system can be provided that provides back-up containment for a single-use trash bag, but wherein the normal action of removing the single-use trash bag does not inherently remove the secondary containment liner as well, which remains in place unless the user deliberately intends to also remove the secondary containment liner to handle a challenging load.

In some embodiments, the secondary containment liner is substantially longer than the single-use trash bag to allow the secondary containment liner to form a sleeve around a portion of a durable trash bag container that contrasts with the sleeve, if present, formed by the shorter single-use trash bag such that workers can readily distinguish between the two and readily be trained to only remove the distinct single-use trash bag while leaving the secondary containment liner in place. In embodiments in which the secondary containment liner is longer than the single-use trash bag intended to be placed within the secondary containment liner, difference in length (measured when the secondary containment liner and single-use trash bag are in a flat, unfolded, empty state) can be about 5 cm or greater, about 10 cm or greater, about 20 cm or greater, about 30 cm or greater, and about 50 cm or greater, such as from 5 cm to 60 cm, from 10 cm to 30 cm, or from 5 cm to 20 cm.

When the absorbent material of the secondary containment liner absorbs malodors, odors can be steadily removed over time, but the capacity of the odor inhibiting agent may eventually be spent. For example, the effectiveness of odor inhibiting agents such as bacterial powders, activated carbon, zeolites, baking soda, sodium hypochlorite, chlorhexidine, and the like can decrease with time. Thus, indicia, timers, or other means can be used to ensure that the secondary containment liner is changed regularly lest the odor absorbent material become ineffective. For example, a label or other indicia associated with the secondary containment liner may be attached to the label, to the durable trash bag container, or other surface in the proximity of the durable trash bag container for indicating when a secondary containment liner needs to be replaced. Timers, smart labels, RFID systems, or other tools may also be used to automate the process. For example, a TimeStrip® Smart Label marketed by TimeStip LLC (Hitchin, England) may be attached to or associated with a secondary containment liner. When it is placed in or attached to trash bag container or other nearby surface, the smart label may be activated by squeezing the blister pack to release a red fluid that slowly begins wicking into a porous strip. The time required for the fluid to wick across the visible span of the strip can approximate the recommended replacement cycle for the secondary containment liner (e.g., one week, two days, etc.), allowing the user to visually determine from the smart label if the secondary containment liner needs to be replaced. Of course, the time strip reading would be ignored if the single-use trash bag had a challenging load potentially requiring both the secondary containment liner and the single-use trash bag to be removed together.

The trash bag container may be a durable item or may itself be disposable, such as a paperboard container intended for a limited number of uses. The trash bag container may comprise two or more separable components such as a body and a cover. The body may be substantially cylindrical or have a rectangular cross-section or any other suitable geometric shape, such as a semi-circle, ellipse, irregular shape, polygons of any kind, including triangles, pentagons, hexagons, and octagons, etc. The cover may be a removable upper section with an opening through which trash can be placed into the single-use trash bag when the cover is in place on the body, or the cover may be a lid or other device that must be removed or displaced to provide access to a single-use trash bag therein. The cover may cover substantially all of the body or leave a significant portion of the body exposed. The secondary containment liner may be attached to the body or may sit freely within the body or, more generally, within the trash bag container.

In typical operation, the single-use trash bag, which may be a conventional trash bag such as a polyethylene film bag, is placed within the trash bag container that has been previously lined with the disposable secondary containment liner having absorbent material. The trash bag container generally holds the secondary containment liner and the single-use trash bag in open positions to allow trash to be placed within the single-use trash bag, generally from the top of the bag, though access to the single-use trash bag may be from either a top or side opening in the trash bag container, for example.

In high-volume situations, where trash bags may be stuffed beyond the intended capacity, removal of the bags often results in spillage. The presence of a secondary containment liner can reduce the risk of contamination of the bottom of the durable trash bag container itself and reduce mess. The presence of the absorbent material can help absorb liquid while also inhibiting odor formation or generally reducing the presence of malodors near or within the trash bag container, and may reduce labor costs associated with cleaning of the trash bag container, as well as reducing waste available to pests such as rodents and insects.

### BRIEF DESCRIPTION OF THE DRAWINGS

FIG. 1 shows a trash bag container lined with a secondary containment liner formed of flexible material having a portion broken away to reveal an absorbent section inside the secondary containment liner.

FIGS. 2A and 2B show a single-use trash bag inside a secondary containment liner that in turn is disposed inside a trash bag container.

FIG. 3 shows an embodiment of an absorbent wafer according to the present invention.

FIG. 4 shows an embodiment of an absorbent wafer according to the present invention.

FIG. 5 depicts a trash bag container with retention means to secure a secondary containment liner to the container.

FIG. 6 depicts a method of manufacturing the trash containment system of the present invention.

FIG. 7 depicts a secondary containment liner with indicia thereon to regulate replacement.

### DETAILED DESCRIPTION

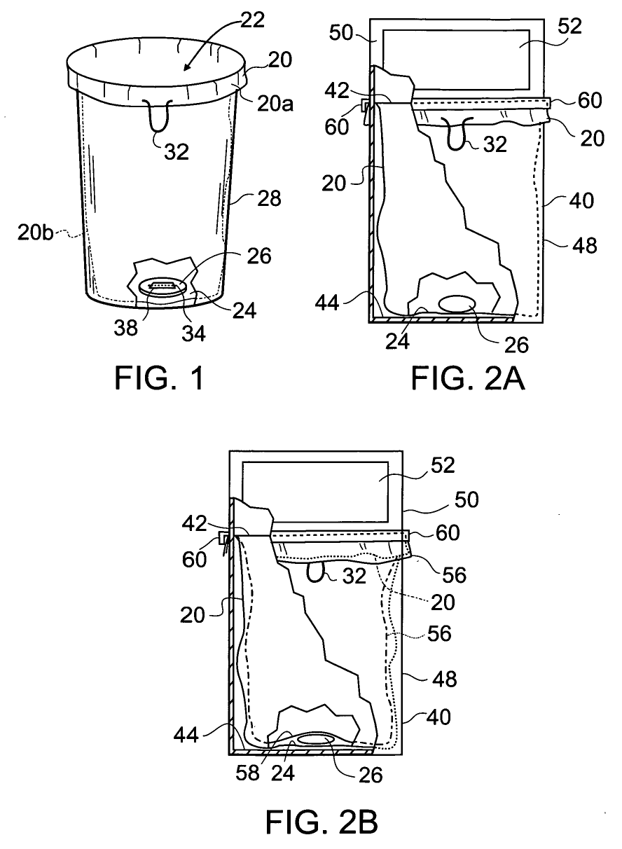

FIG. 1 shows a secondary containment liner 20 having an open top 22 and a sealed bottom 24, located in a rigid trash bag container 28. The liner 20 comprises a waterproof material such as polyethylene or other plastic materials and may be highly flexible of self-supporting. The secondary containment liner 20 has an exposed outer portion 20a extending past the upper opening of the trash bag container 28 and contained internal portion 20b inside the trash bag container 28. An absorbent section 26 such as a wafer of absorbent material or a sponge is placed at the bottom 24 of the liner 20, facing the interior region thereof. The absorbent section 26 can be formed of the ZORBA™ absorbent material marketed by JohnsonDiversey Corp. (Racine, Wis.), or can be comprise any other suitable absorbent materials. The absorbent section 26 can be adhered the to the bottom 24 of the liner 20 by a drop of silicone adhesive or any other suitable adhesive (not shown). The absorbent section 26 may be impregnated with a concentrated bacterial agent to reduce odors that may be formed by bacteria growing in the waste, particularly in liquid portions thereof. An exemplary bacterial agent is BEC 150 distributed by Genesis Technologies International (Lawrenceville, Ga.). BEC 150 is a concentrated bacterial powder comprising a mixture of natural microorganisms that are believed to not be hazardous to human health or the health of other mammals, and is believed to have the ability to break down proteins, carbohydrates, animal and vegetable fats, oils and cellulose for effective waster digestion and odor reduction, as it destroys or prevents the formation of many malodors without the need for a fragrance or masking agents. It is believed that when wetted, the bacteria become active and produce enzymes that degrade some waste products and reduce odors. This product is typically used as a powdered concentrate, for dilution with organic fillers such as wheat bran, corn cob fractions, etc. BEC 150 is a 50 billion cfu/gram powder. Typical end use products are 1 billion-5 billion cfu/gram products. BEC 150 as well as related products from the BEC products series marketed by Genesis Technologies International can be provided in loose form or a water soluble bio-pouch, with multiple carrier options available such as lactose, coarse wheat bran, fine wheat bran, rice bran, wood flour, pecan flour, flax seed, sodium bicarbonate, sodium sulfate, dendritic salt and dextrose. The amount of BEC 150 or other bacterial powders per absorbent wafer 16 can be from about 0.5 g to about 100 g, 0.5 g to about 25 g, or from about 0.5 g to about 10 g, such as from about 1 g to about 4 g.

By way of example, the system of FIG. 1 could be adapted for a standard 39 gallon trash bag 20 that could include an absorbent section 26 about 30 cm in diameter and impregnated with about 5 grams to 100 grams of bacterial powder or other odor inhibiting agents. In order to reduce the escape of the concentrated bacterial powder from the absorbent section 26, an opening 34 may be cut in the absorbent section 26 for initial injection of an odor inhibiting agent, and then the opening can be sealed with a glue strip or tape 38. The glue strip or tape 38 could be removed before use to activate (or more rapidly access) the odor removing capability of the absorbent section 26, if desired. Further, an insecticide (not shown) may also be added to the liner 20 in combination with the absorbent section 26 or placed on the inside or outside of the liner 20, including any suitable EPA registered insecticide.

The liner 20 may include a drawstring 32 to secure the liner 20 to a trash container 28 or for subsequent closing of the liner 20 when it is removed and discarded. Other means of securing the liner 20 may be used such as a rubber band (not shown), etc.

When certain biological materials are used as odor inhibiting agents in the absorbent section 26, such as bacterial powders, full activation of the odor inhibiting function may require the presence of moisture. In some applications of the present invention, the odor inhibiting function of such materials may only be needed when there is excess liquid present in the waste, such that fluid reaches the absorbent section 26, thus automatically activating the biological odor inhibiting agents therein. In other cases, such as in the management of inherently malodorous wastes such as feces from animals or infants (e.g., for a diaper pail), it may be desirable to activate a biological odor inhibiting agent prior to or during insertion of the secondary containment liner 20 into a trash bag container 28. In such cases, the user may spray, pour, or otherwise apply a predetermined amount of water onto the absorbent section 26, such as between about 5 grams and about 200 grams of water, or between about 10 grams and 70 grams of water. In one embodiment, the necessary water for activation of a biological odor inhibiting agent can be packaged with the secondary containment liner 20, such as being provided in a sealed pouch attached to or adjacent the absorbent section 26, wherein the user can break a frangible seal to directly apply water into the absorbent section, or open the pouch or other container to apply water to the absorbent section 26, or the like.

FIG. 2A shows a secondary containment liner 20 placed within a trash bag container 40 similar to the trash cabinets used in fast food restaurants. The container 40 has a lower body 48 and an upper cover 50 with a pivoting door 52 through which waste can be dropped into the container 40. The liner 20 is folded over the top edge 42 of the lower body 48 of the container 40 and beneath a lip 60 of the upper cover 50. The liner 20 may be secured with the drawstring 32. The drawstring 32 is merely a suggested means of securing the liner 20 to the container 40 and other means may be used or omitted altogether. The liner 20 may be suspended from the container edge 42 or the bottom 24 of the liner 20 may rest on the base 44 of the container, or both.

FIG. 2B shows the trash container 40 of FIG. 2A, but now further containing a single-use trash bag 56 within the secondary containment liner 20. With the single secondary containment liner 20 in place, a single-use trash bag 58 may be installed, filled with trash (not shown), removed and discarded, after which a new single-use trash bag 58 can be installed inside the secondary containment liner 20 and the cycle repeated until it is time to also replace the secondary containment liner 20. Thus, multiple single-use trash bags 58 can be used while a single secondary containment liner 20 remains in place to inhibit malodors and reduce the risk of leakage, thereby maintaining a clean interior for the trash bag container 40, reducing the risk of malodors outside the trash bag container 40, and reducing the risk of spillage or leakage when the single-use trash bag 58 is removed and discarded.

Another aspect of the present invention includes the color coding of different sized liners 20 which may have absorbent wafers 26 of proportional size and having a proportional amount of concentrated bacterial powder therein. In this system, each different size of liner 20 would have a different color so that different sizes would be readily apparent. When a liner 20 needed to be changed, another cold be readily selected by color. This feature takes on added importance in a public area having different sized containers. The time for change of the liner 20 can be determined when the absorbent section 26 is fully saturated. In such a situation, replacement liners may not be stored with the original packaging which designates its size, but it would be easy for the janitorial crew to determine which liners go with which trash containers merely by matching colors rather than trying to estimate the size of liner required for a particular container. Further, each differently colored liner 20 can have a differently sized absorbent section 26 which has a correspondingly proportional amount of concentrated bacterial powder or other odor absorbing or neutralizing materials, and/or liquid absorbent material.

The container 48 as depicted in FIGS. 2A and 2B shows a pivoting door 52 that can be opened manually. Alternatively, the door 52 could be opened by a automated means, by a foot pedal (as described, for example, in U.S. Pat. No. 5,147,056), or by other means, depending on the location of the door (e.g., it may be a trap door on the upper surface of the container 48, such as the trap door mechanism described in U.S. Pat. No. 2,531,503, “Trap Door Hopper Top,” issued Nov. 28, 1950 to M. Dick). A pivoting door mechanism may be used such as that described in U.S. Pat. No. 6,267,260, “Trash Container Door Opening Apparatus,” issued to K. J. Lyons Jul. 31, 2001, which pertains to an apparatus for opening a trash container door flap for use in limited-service or fast-food restaurants and other facilities. The apparatus includes a means of attachment to the door flap from which a hand lever and/or a line to a foot pedal may be attached. Another system for managing the opening of doors to trash containers is described in US20040174268, “Systems, Methods, and Devices for Manipulating a Trash Container Door Flap,” issued to Scott and Thrasher Sep. 9, 2004, which can be used with the present invention.

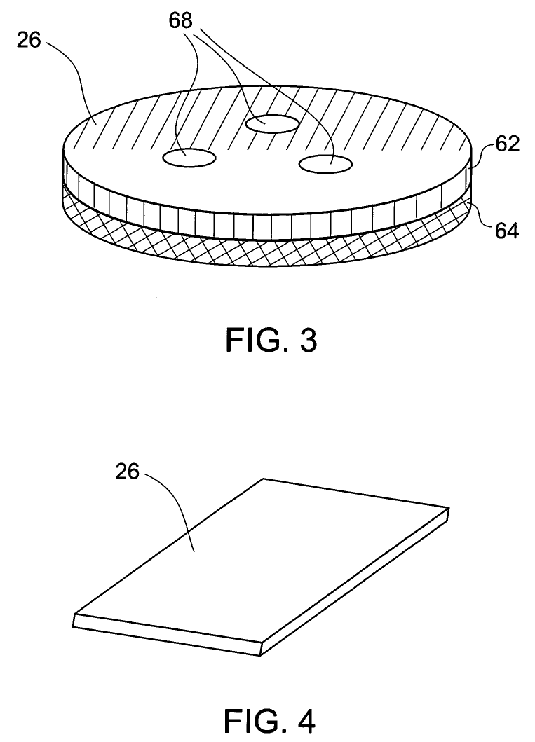

FIG. 3 shows one embodiment of an absorbent section 26 in the form of a cylindrical wafer comprising a first layer 62 of absorbent material and a second layer 64 of absorbent material. The layers 62,64 may comprise differing absorbent materials or may comprise the same absorbent material, such as nonwoven webs, tissue layers, wood pulp, and the like. The first layer 62 as depicted comprises three zones 68 of odor inhibiting agent impregnated or otherwise attached to the first layer 62 of absorbent material. The odor inhibiting agent 68 may be a single material such as a bacterial powder added to all three zones, or may comprise two or more different materials discretely located in the zones 68, such as bacterial powder in one zone, activated carbon in another, and an oxidizing agent in yet another. The second layer 64 may also comprise odor inhibiting agent embedded therein (not shown), or odor inhibiting agent may also be sandwiched between the first layer 62 and second layer 64 (sandwiched odor inhibiting agent not shown).

FIG. 4 depicts a rectangular absorbent section 26 serving as shaped absorbent wafer corresponding to the cross-sectional shape of the body of trash bag container (not shown) such that the absorbent section 26 can help maintain the shape of a trash liner (not shown) to better fill the cross-section of the trash bag container.

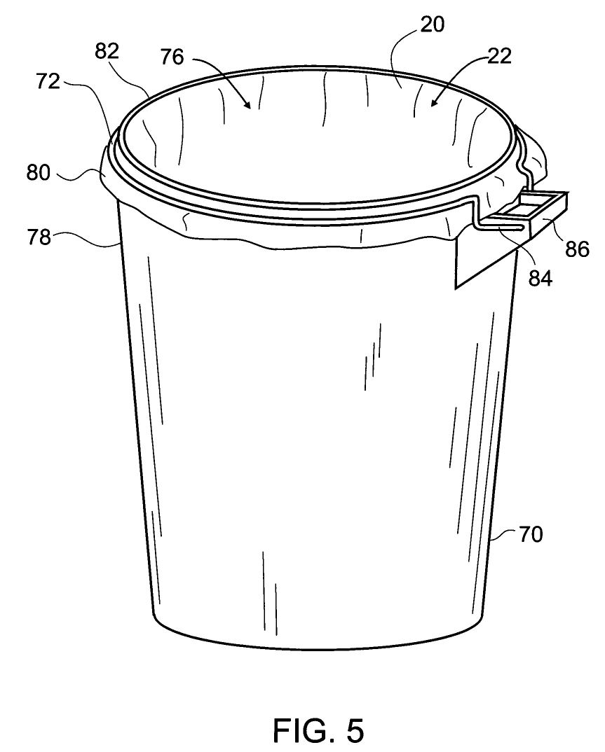

FIG. 5 depicts a trash bag container 70 having a liner retention system to secure a secondary containment liner 28 in place. The figure is based on a related trash can described in U.S. Pat. No. 5,740,939, “Liner Retainer,” Issued Apr. 21, 1998 to Muldner and Brennan (see particularly FIGS. 1-3 therein), the portion thereof describing FIGS. 1-3 being herein incorporated by reference to the extent that it is noncontradictory herewith. In FIG. 5, the trash bag container 70, a secondary containment liner 20 and a liner retainer 72. The container 70 includes a mouth 76 and a side 78. The liner 20 hangs within the container 70. The liner 20 has a mouth 22 and a folded portion 80 which folds over the upper rim 82 of the container 70 defining the mouth 76 of the container 70. The liner retainer 72 secures the end of the liner 20 over the mouth 76 of the container 70.

The liner retainer 72 has a connector member 84 that engages into a handle 86 allowing the loop of the liner retainer 72 to lock into place against the trash bag container 70 to retain the liner 20. The retainer member 30 has a portion defined in the shape of a loop 32. The liner retainer 72 is elastic and formed in the shape of a loop, and can stretch to circumscribe the container 70 and hold the liner 20 in place with the container 70. Not shown is the single-use trash bag that can be placed inside the secondary containment liner 20. The single-use trash bag (not shown) can also be attached with the liner retainer 72, if desired, but need not be. A trash can lid (not shown) can also be placed over the container 70.

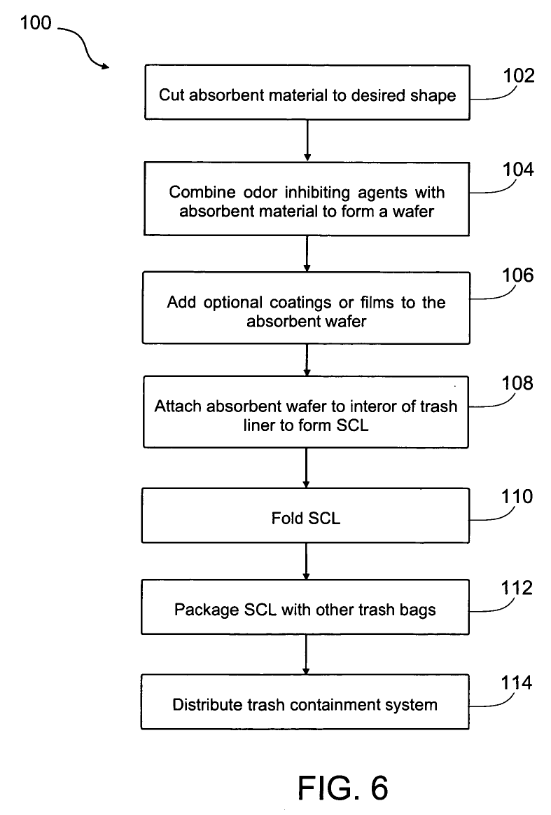

FIG. 6 describes a method of manufacturing 100 packaged trash containment systems containing secondary containment liners with absorbent materials according to the present invention. The method of manufacturing 100 described provided by way of example, and it is understood that many variants are possible within the scope of the present invention. According to the method 100, absorbent materials for the absorbent section of the secondary containment liner are cut to the desired shape 102, and then combined with odor inhibiting agents 104. The absorbent wafer so formed may the be coated in whole or in part with coatings or films 106 to protect active ingredients in the absorbent wafer, such as preventing premature activation of biological odor inhibiting agents. For example, regions of an absorbent wafer comprising biological odor inhibiting agents may be covered with a liquid impermeable release strip that can be removed upon use to allow the biological odor inhibiting agent to contact water (which may be applied by the user, if desired) and begin its lifespan as a biologically active odor inhibiting agent.

The absorbent wafer is then attached to the interior of a trash liner to form a secondary containment liner 108. This step can be conducted by hand or by machine, and generally involves using an adhesive, double-sided tap, or other joining means to attach the absorbent wafer to the interior bottom of the liner. In one automated version, adhesive is placed on a surface of the absorbent wafer, which is then placed in contact with the bottom of the liner. The liner may be inverted into an inside-out configuration with a pressing member inside the inverted liner that presses the exposed bottom of the liner against the adhesive on the wafer, after which the liner is inverted again to result in an attached absorbent wafer inside the bag on the bottom thereof.

The secondary containment liner with its attached absorbent wafer can then be folded 110 and compressed, if desired, prior to packaging the secondary containment liner with other trash bags 112, such as other secondary containment liners and/or single-use trash bags that may or may not contain attached absorbent material as well. The bags may be color coded and marked with suitable indicia to guide usage by end users. The packaged trash containment system can then be distributed via commercial channels 114.

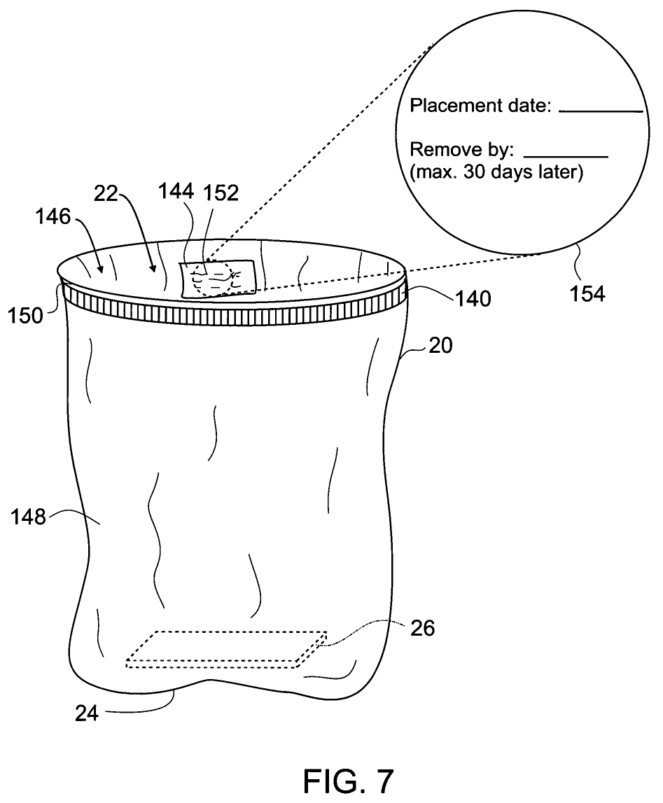

FIG. 7 depicts a secondary containment liner 20 having a mouth 22, an interior portion 146, an exterior portion 148, a bottom 24, and a top 150, with a colorful band 140 around the exterior top portion of the bag. Depending on how the secondary containment liner 20 interacts with a trash bag container (not shown), it may be desirable to place the colorful band 140 around the top of the interior portion 146 instead (interior placement not shown). Also shown is a label 144 with indicia 152 for guiding timely replacement of the secondary containment liner 20 to ensure that the odor inhibiting agents (not shown) in the absorbent section 26 remain active during the use cycle of the secondary containment liner 20. As shown in an expanded view 154 of the indicia 152, placement date and the target replacement date can be marked. When the current date reaches the target replacement date (here, noted as 30 days after the placement date), the secondary containment liner 20 should be replaced. Replacement can be earlier, of course, in response to leakage of single-use trash bags or other contamination of the secondary containment liner 28.

### The Absorbent Material

The absorbent material in secondary containment liner can comprise any known material capable of absorbing and/or neutralizing odors, and/or absorbing liquids. The material may be provided in the form of a wafer such as a disk or substantially flat layer of material having, for example, characteristic in-plane dimension of width and length that can both be between about 2 cm and 30 cm, or larger when needed, with characteristic thickness from about 0.1 cm to about 5 cm, such as from 0.5 cm to 2 cm or from about 0.3 cm to about 3 cm. Two or more wafers maybe used, with a total mass of dry absorbent material per secondary containment liner that can be, without limitation, from about 10 g to 500 g or greater, if needed, such as from about 20 g to 150 g or from about 10 g to 100 g.

The absorbent material can be characterized in terms of its absorbent capacity, measured as the amount of distilled water at 25° C. that can be retained in the absorbent material in a horizontal position while supported on a water impervious backing. The absorbent material is initially in a relatively dry state after being conditioned at 50% relative humidity at 23° C. for 24 hours and its mass is taken. It is placed on a water impervious, hydrophobic film (e.g., Saran® wrap) to permit ease of handling when wet. The water is then gently sprayed onto the absorbent material to fully wet it, and after sitting for 10 minutes, additional water is sprayed on the absorbent material until water leaks from the sides of the absorbent material. Any free standing water is blotted away. The mass of the saturated absorbent material is then taken. The added mass of absorbed water is the absorbent capacity, and the absorbent capacity divided by the initial mass of the conditioned absorbent material prior to wetting is taken as the relative absorbent capacity. The absorbent capacity, for example, may be greater than 20 grams, 100 grams, or 500 grams, and may range from about 20 grams to 5000 grams, such as from about 50 grams to 2000 grams, or from about 100 grams to about 1000 grams, or from about 100 grams to 500 grams. The relative absorbent capacity may be greater than 1, 2, 5, or 8, and may range from about 1 to about 70, such as from about 5 to 50, from about 5 to 30, or from about 2 to 25.

In some embodiments, the material is capable of neutralizing the sources of some malodors as well as absorbing liquids. In such embodiment, odor neutralization can be achieved by any known method, including the use of enzymes to attack bacteria or materials that contribute to odor generation. Many different bacteria strains can contribute to malodor generation. For example, malodor may originate from the activity of Staphylococcus species (such as S. aureus, S. epidermis, S. intermedius, S. saprophyticus and S. hyicus). A variety of enzymes can be useful in directly or indirectly limiting the generation of malodors and/or the activity of malodor generating microorganisms. Useful enzymes can include classes such protease, peroxidase, oxidase, lipase, amylase, cellulase, etc., including endopeptidase, etc. Useful enzymes may be provided as such, or may be generated by the activity of microorganisms that are intentionally added to the absorbent material. For example, bacterial powders or other probiotics can be added to the absorbent material which, in the presence of waste matter such as liquid waste, can become active and produce enzymes or other agents that inhibit malodor generation. Useful biologically generated agents that can help reduce malodors include lactic acid and other acids, enzymes, antibiotics, etc.

Antimicrobial agents can also be incorporated into the absorbent material or elsewhere in the trash containment systems of the present invention, as described below.

The absorbent material may comprise two or more distinct materials that may be distributed in discrete layers, in discrete regions in the liner, as a mixture, etc. One portion of the absorbent material can be, for example, a cellulosic material such as comminuted fibers, paper layers, regenerated cellulosic sponge materials, fibrous nits, cotton pads or other natural plant materials, etc. Tissue or paper layers or laminates may be considered, such as layers of paper towels, creped tissue, uncreped tissue, and the like. Composite materials may be used such as commercial absorbent articles such as sanitary napkins, pantiliners, incontinence pads, diaper cores, and the like. Nonwoven materials such as meltblown, spunbond webs, or coform webs (cellulosic fibers combined with meltblown polymeric fibers such as polyolefins) may be used alone or in combination with other absorbent materials.

Superabsorbent materials (SAM) and related swellable polymers or hydrogels may be used. Commercial SAMs are typically crosslinked poly(acrylic acid) or acrylic acid grafted on starch. The carboxyl functionality is partially neutralized with sodium or potassium hydroxide. Some versions involve graft polymerizing acrylonitrile onto gelatinized starch followed by hydrolysis of the polyacrylonitrile to poly(acrylic acid-co-acrylamide). Although primarily acrylic acid-based SAMs are disclosed in conjunction with the present invention, it should be understood that other types of SAM may be contemplated for use. SAM may be provided in the form of particles, pellets, fibers, films, and other forms. Patents which disclose hydrogel-forming polymer compositions for use in absorbent structures include: U.S. Pat. Nos. 5,147,343 to Kellenberger; 3,901,236 to Assarsson et al.; 4,062,817 to Westerman; 4,076,663 to Masuda et al.; 4,286,082 to Tsubakimoto et al.; 4,340,706 to Obayashi et al.; 4,473,689 to Login et al.; 4,535,098 to Evani et al.; European Patent 75,510; and Re. 32,649 to Brandt et al.

Odor inhibiting agents can include various odor absorbent materials. Such odor absorbent materials include zeolites, activated carbon, sodium bicarbonate, cyclodextrins and derivatives thereof, etc.

The absorbent material can be provided in a pouch, pellets, etc., in an absorbent layer that may be located inside the secondary containment liner at or near the bottom thereof. Alternatively or in addition, odor absorbent material may be provided near the top of the secondary containment liner. In one embodiment, a separate section of odor material can be attached to the durable trash bag container, such as on the underside of a cover thereof or on a surface near the mouth of the single-use trash bag.

Foams can be used, such as hydrophilic foam materials. The foam may be a single layer, in multiple layers, in discrete fragments or chunks, etc., and may be impregnated or combined with other absorbent materials.

Foam materials may be joined to or otherwise combined with tissue, paper towels, or other cellulosic materials to form laminates. For example, a foam or a material comprising odor-absorbing particulates or liquid-absorbing particulates may be sandwiched between two paper or tissue layers. A sponge, such as a polyurethane or cellulosic sponge, may be impregnated with absorbent materials and/or antimicrobial materials, including enzymes.

An absorbent wafer may be attached to bottom of the secondary containment liner by adhesive means (e.g., silicone glue, hot melt, epoxy, etc.), mechanical means (e.g., a hook and loop pad), etc., or may be unattached but simply pre-disposed in the bottom of the secondary containment liner or added to the bottom of the secondary containment liner by the user. The absorbent wafer can be customizable, such that users are provided with a choice of absorbent wafers to place in the secondary containment liner to serve as the primary absorbent material or to serve as a supplemental absorbent material in addition to a pre-attached wafer in the bags. Customization of the absorbent material allows users to apply extra absorbent for use in demanding settings such as a high-volume food-court.

### Enzymatic and Other Biological Ingredients

One exemplary enzyme-containing product that can be incorporated with the absorbent material is BEC 150 by Genesis Technologies International (Lawrenceville, Ga.). Other enzyme-based odor control agents include the CLASSI series of products from Clean Air Systems, Inc., (Ft. Lauderdale, Fla.). Enzymes in the absorbent material may remain inert until wetted, and then can begin functioning (provided the temperature range is acceptable, such as between about 50° F. and 120° F.), or can be produced by microorganisms that are activated by the presence of liquid or other waste material that contacts the absorbent material of the secondary containment liner.

Enzymes useful for reducing malodors and methods of use and preparation can include any of those in the following: WO/1991/010723, “Bacteriolytic Enzyme Native to a Nocardiopsis Strain, Its Production and Use”; WO/1997/031999, “Cleaning Compositions Comprising Endo-Dextranase”; WO/1997/043378, “Detergent Compositions Comprising a Combination of ‘Alpha’-Amylases for Malodor Stripping”; U.S. Pat. No. 6,287,585, “Methods for Laundry Using Polycations and Enzymes”; and WO/1999/009143, “Reduction of Malodour.”

When enzymatic components are present in the absorbent material, any of the following may be used, alone or in combination. These compounds are listed by way of example only:

Proteases: Suitable proteases include those of animal, vegetable or microbial origin. Chemically modified or protein engineered mutants are included. The protease may be a serine protease or a metallo protease, such as an alkaline microbial protease or a trypsin-like protease. Examples of alkaline proteases are subtilisins, including those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g. of porcine or bovine origin) and the Fusarium protease described in WO 89/06270 and WO 94/25583. Other examples of proteases are the variants described in WO 92/19729, WO 98/20115, WO 98/20116, and WO 98/34946.

Commercially available protease enzymes include Alcalase™, Savinase™, Primase™, Everlase™, Esperase™, and Kannase™ (Novozymes A/S), Maxatase™, Maxacal™, Maxapem™, Properase™, Purafect™, Purafect OXP™, FN2™, and FN3™ (Genencor International Inc.).

Lipases: Suitable lipases can include those of bacterial or fungal origin. Chemically modified or protein engineered mutants are included. Examples include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202. Commercially available lipase enzymes include Lipolase™, Lipolase Ultra™ and Lipoprime™ (Novozymes A/S).

Amylases: Suitable amylases (a and/or P) include those of bacterial or fungal origin. Chemically modified or protein engineered mutants are included. Amylases include, for example, alpha-amylases obtained from Bacillus, e.g. a special strain of B. licheniformis, described in more detail in GB 1,296,839.

Examples of useful amylases are the variants described in WO 94/02597, WO 94/18314, WO 96/23873, and WO 97/43424. Commercially available amylases are Duramyl™, Termamyl™, Fungamyl™ and BAN™ (Novozymes A/S), Rapidase™ and Purastar™ (Genencor International Inc.).

Cellulases: Suitable cellulases include those of bacterial or fungal origin. Chemically modified or protein engineered mutants are included. Exemplary cellulases include cellulases from the genera Bacillus, Pseudomonas, Humicola, Fusarium, Thielavia, Acremonium, e.g. the fungal cellulases produced from Humicola insolens, Myceliophthora thermophila and Fusarium oxysporum disclosed in U.S. Pat. Nos. 4,435,307, 5,648,263, 5,691,178, 5,776,757 and WO 89/09259. Also to be considered are the cellulases described in EP 0 495 257, EP 0 531 372, WO 96/11262, WO 96/29397, WO 98/08940, and the cellulase variants such as those described in WO 94/07998, EP 0 531 315, U.S. Pat. Nos. 5,457,046, 5,686,593, 5,763,254, WO 95/24471, and WO 98/12307.

Commercially available cellulases include Celluzyme™, and Carezyme™ (Novozymes A/S), Clazinase™, and Puradax HA™ (Genencor International Inc.), and KAC-500(B)™ (Kao Corporation).

Peroxidases/Oxidases: Peroxidases/oxidases for use in the present invention may include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257.

Enzymes may be combined with detergents, if desired, or may be combined with other carriers or additives and can be formulated, for example, as a granulate, a liquid, a stabilized slurry, etc. Enzyme-containing compounds may be provided in non-dusting granulates as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

For the production of enzymes or other useful biological agents in reducing odors o bacteria associated with some forms of trash, a variety of microorganisms can be incorporated in the absorbent material or otherwise added to the secondary containment liner, the single-use trash bag, or to components attached to the trash bag container. Such microorganisms can include bacterial powders or other pro-biotic agents that may generally comprise a bacteria whose presence can inhibit the growth of harmful or odor-generating bacteria. Useful bacteria strains such purposes can include lactic acid generating bacterial, prepared, for example, as described in EP1514553, “Lactic Acid Bacteria Powder Double-Coated Using Protein and Polysaccharide and Method Preparing the Same and a Dosage Form Thereof” in the name of Chung et al., herein incorporated by reference to the extent that it is noncontradictory herewith.

Probiotic materials are also marketed by Roebic Technology, Inc., a unit of Roebic Laboratories, Inc. Their bacteria cultures originally developed for wastewater treatment now make up the Roetech® commercial line for consumer and food service products. Particular products include: Bacillus macerans; ATCC 202132; Bacillus amyloliquefaciens; ATCC 202133; Bacillus amyloliquefaciens; ATCC 202134; Bacillus macerans; ATCC 202135; Bacillus pumilus; ATTC 202136; Bacillus subtilis; ATTC 202137; Bacillus subtilis; ATTC 202138; and Bacillus subtilis; ATTC 202139.

Some of these strains are believed to be described by U.S. Pat. No. 6,174,718, “Enzyme-Producing Strain of Bacillus Bacteria,” issued Jan. 16, 2001 to David Lawler and Steven Smith, herein incorporated by reference to the extent that it is noncontradictory herewith. Described therein is a strain of Bacillus bacteria that produces lipase enzymes for the degradation of oleaginous materials such as fats, greases and cooking oils, and protease enzymes to degrade proteins.

Other strains in the Roetech® series of bacterial products are believed to be described by the following U.S. Pat. Nos. 6,171,848; 6,171,847; 6,177,012; 6,083,737; 6,140,106; 6,162,634; and 6,162,635; all of which are herein incorporated by reference to the extent that it is noncontradictory herewith.

### Other Antimicrobial Agents

Other antimicrobial agents that may be included in the products and systems of the present invention include those that release silver ions, quaternary ammonium salts, tri-butyl tin oxide and other metal salts, peroxide/peracid mixtures, mineral chelated salts, other oxidation catalysts, etc. When biological odor inhibiting agents are present, any antimicrobial agents can be adapted to not interfere with the biological odor inhibiting agent, such as by placing the antimicrobial agents in locations separated from contact with the biological odor inhibiting agent, or using antimicrobial agents that are compatible with the odor inhibiting agents.

In one embodiment, the antimicrobial agent is dispersed homogeneously throughout the absorbent material. In another embodiment, the antimicrobial agent is bound or entrained within portions of the absorbent material.

Odor inhibiting agents can include antimicrobial fabrics and related materials available from a number of sources including Sherman Textile Company of Dallas, N.C.; Magna Fabrics of North Bergen, N.J.; and Microban® Products Company of Huntersville, N.C. A exemplary anti-microbial fabric is the Microsafe® fabric produced by Microban® Products Company. Antimicrobial fabrics may also serve as part of the liquid absorbent function of the absorbent material. Silver ion releasing agents may be used for their antimicrobial effect. An exemplary antimicrobial silver-based compound is manufactured by Agion Technologies and sold under the name AGION®. An alternative inorganic antimicrobial compound suitable for use is a silver and zinc oxide-based compound made by Du Pont Specialty Chemicals under the name MICROFREE®.

Further non-limiting examples of antimicrobial agents include a variety of liquids and solids that can be disposed in the absorbent materials of the present invention include:

Acids: Include effective organic and inorganic acids known in the art, including, but not limited to: citric acid, cresylic acid, dodecylbenzene sulfonic acid, phosphoric acid, salicylic acid, sorbic acid, sulfamic acid, acetic acid, benzoic acid, boric acid, capric acid, caproic acid, cyanuric acid, dihydroacetic acid, dimethylsulfamic acid, propionic acid, polyacrylic acid, 2-ethyl-hexanoic acid, formic acid, fumaric acid, 1-glutamic acid, isopropyl sulfamic acid, naphthenic acid, oxalic acid, phosphorus acid, valeric acid, benzene sulfonic acid, xylene sulfonic acid, as well as any acid listed as a registered pesticide active ingredient with the United States Environmental Protection Agency. Further useful acids include: sulfonic acids, maleic acid, acetic acid, adipic acid, lactic acid, butyric acid, gluconic acid, malic acid, tartaric acid, as well as glycolic acid. Desirably glycolic acid and citric acid are used as they are effective and in plentiful supply.

Alcohols such as ethanol, isopropanol, and n-propanol.

Biguanides such as polyhexamethylene biguanide (PHMB), chlorhexadine gluconate (CHG).

Hypohalous Acid and Salts: Hypohalite, defined as hypohalous acid and/or salts thereof. Suitable hypohalous acids and salts may be provided by a variety of sources, including compositions that lead to the formation of positive halide ions and/or hypohalite ions, as well as compositions that are organic based sources of halides, such as chloroisocyanurates, haloamines, haloimines, haloimides and haloamides, or mixtures thereof. These compositions may also produce hypohalous acid or hypohalite species in situ. Suitable hypohalous acids and salts for use herein include the alkali metal and alkaline earth metal hypochlorites, hypobromites, hypoiodites, chlorinated trisodium phosphate dodecahydrates, potassium and sodium dichloroisocyanurates, potassium and sodium trichlorocyanurates, N-chloroimides, N-chloroamides, N-chlorosulfamide, N-chloroamines, chlorohydantoins such as dichlorodimethyl hydantoin and chlorobromo dimethylhydantoin, bromo-compounds corresponding to the chloro-compounds above, and compositions which generate the corresponding hypohalous acids, or mixtures thereof.

Inorganic oxides/hydroxides: Insoluble inorganic oxides with isoelectric points greater than the pH of the solution has been shown to be very efficient at the physical removal of microorganisms (bacteria and virus). Such compounds include magnesium hydroxide, calcium hydroxide, magnesium oxide, aluminum oxide, iron oxide, cerium oxide, zinc oxide, zirconium oxide, barium oxide, calcium oxide, hydroxyapatite, chromium oxide, cobalt oxide, cesium oxide, etc. The antimicrobial capability of these materials can be improved by the doping of antimicrobial metals such as silver and the other metals listed above. These metals can also be doped into other inorganic oxides such as silicates for antimicrobial action.

Metals: Additional antimicrobial agents are antibacterial metal salts. This class generally includes salts of metals in groups 3b-7b, 8 and 3a-5a. Specifically are the salts of aluminum, zirconium, zinc, silver, gold, copper, lanthanum, tin, mercury, bismuth, selenium, strontium, scandium, yttrium, cerium, praseodymiun, neodymium, promethum, samarium, europium, gadolinium, terbium, dysprosium, holmium, erbium, thulium, ytterbium, lutetium and mixtures thereof.

Naturals: Also useful as antimicrobial agents are the so-called “natural” antibacterial actives, referred to as natural essential oils. These actives derive their names from their natural occurrence in plants. Typical natural essential oil antibacterial actives include oils of anise, lemon, orange, rosemary, wintergreen, thyme, lavender, cloves, hops, tea tree, citronella, wheat, barley, lemongrass, cedar leaf, cedarwood, cinnamon, fleagrass, geranium, sandalwood, violet, cranberry, eucalyptus, vervain, peppermint, gum benzoin, basil, fennel, fir, balsam, menthol, ocmea origanum, Hydastis carradensis, Berberidaceae daceae, Ratanhiae and Curcuma longa. Also included in this class of natural essential oils are the key chemical components of the plant oils which have been found to provide the antimicrobial benefit. These chemicals include, but are not limited to anethol, catechole, camphene, carvacol, eugenol, eucalyptol, ferulic acid, farnesol, hinokitiol, tropolone, limonene, menthol, methyl salicylate, thymol, terpineol, verbenone, berberine, ratanhiae extract, caryophellene oxide, citronellic acid, curcumin, nerolidol and geraniol.

Phenols: Triclosan®, Parachlorometaxylenol (PCMX), etc.

Quats: Quats: these quaternary compounds include benzalkonium chlorides and/or substituted benzalkonium chlorides, di(C6-C14)alkyl di short chain (C1-4 alkyl and/or hydroxyalkl) quaternaryammonium salts, N-(3-chloroallyl)hexaminium chlorides, benzethonium chloride, methylbenzethonium chloride, and cetylpyridinium chloride. Other quaternary compounds include the group consisting of dialkyldimethyl ammonium chlorides, alkyl dimethylbenzylammonium chlorides, dialkylmethylbenzylammonium chlorides, and mixtures thereof. Biguanide antimicrobial actives including, but not limited to polyhexamethylene biguanide hydrochloride, p-chlorophenyl biguanide; 4-chlorobenzhydryl biguanide, halogenated hexidine such as, but not limited to, chlorhexidine (1,1′-hexamethylene-bis-5-(4-chlorophenyl biguanide) and its salts are also in this class.

Specific exemplary antimicrobial agents include natural antibacterial actives, such as tea tree oil, lemon oil, mint oil, available from Firemenich, Lactic Acid, available from PURAC; d-limonene available from Millennium Specialty Chemicals; quaternary ammonium compounds available from Lonza; silver di-hydrogen citrate available from Ciba Specialty Chemicals and mixtures thereof, as well as chitosan and chitosan derivatives.

The antimicrobial agents can represent any suitable percentage of the mass of the absorbent wafer or other odor inhibiting agent components in the trash containment systems of the present invention. For example, antimicrobial agents may be present from about 0.01 to about 20 weight percent, or from about 1 to about 10 weight percent in the absorbent section or other component.

### Packaged Systems

Packaged products according to the present invention may include one or more secondary containment liners having a first color or other property, and an equal or greater number of single-use trash bags having a second color or other property, wherein the secondary containment liners are readily distinguished in appearance from the single-use trash bags.

In embodiments wherein moistening of the absorbent material (or a portion thereof, such as a portion containing a biological agent) by water or another liquid is desirable to activate odor inhibiting agents in the absorbent material, liquid application means may also be marketed with and generally associated with the secondary containment liners. The liquid application means may include a spray bottle, a plastic measuring spoon or cup for dispensing the correct amount of liquid, a liquid-filled pouch with a frangible seal joined to the absorbent material such that the pouch can be squeezed to break the seal and deliver a suitable amount of liquid into the absorbent material or a selected portion thereof to activate an odor inhibiting agent such as a bacterial powder, liquid in frangible capsules that can be released by pressing or bending the absorbent material, etc. Association of a water source with the secondary containment liner can include attaching the source of water to the secondary containment liner such as adhering or fastening a liquid pouch to the absorbent material, providing a water applicator with the secondary containment liner to allow the user to manually apply water to the absorbent material or portion thereof (e.g., packaging the secondary containment liner with a spray bottle that can be filled to apply water to the absorbent material), etc.

The packaged product may further comprise means for guiding the replacement of the secondary containment liner to prevent it being left in place too long. Thus means may comprise indicia such as labels or tags that can be marked with the replacement time, or timing aids such as a TimeStrip® timing device, etc.

### Interaction with the Trash Bag Container

The secondary containment liner may be attached to the durable trash bag container by any known means. For example, when the durable trash bag container comprises a vertical hollow chamber open at the top with a rim (the hollow chamber may be the body of a multiple part container), the upper portion of the secondary containment liner may fold over the rim and extend a distance down the outer surface of the hollow chamber to form a sleeve of the chamber. When the size of the secondary containment liner is suitably selected to be only slightly larger than the size of the vertical chamber, or when there is suitable friction between the secondary containment liner and the vertical chamber, the secondary containment liner can remain held in place by the sleeve Alternatively, the portion of the secondary containment liner extending to or beyond the inner rim (e.g., past the rim and down the outer surface of the vertical chamber) of the vertical chamber can be held in place by a clasp, an adjustable or elastic band, one or more snaps, hook and loop fasteners such as those marketed by Velcro USA. or by the constraint applied by adding a cover over the vertical chamber, which may apply clamping force to the portion of the secondary containment liner along the rim of the vertical body or may fit snugly over the outer surface of the upper portion of the vertical chamber to apply force against a secondary containment liner material in contact with the outer surface of the vertical chamber, thereby restraining it from sliding back into the interior portion of the vertical chamber. In several of these embodiments, it may be desirable that the length of the secondary containment liner is substantially greater than the height of the vertical chamber, such that the bottom of the secondary containment liner can rest in place against a bottom surface in the durable trash bag container while being long enough to extend beyond the rim at the top of the vertical chamber. In one embodiment, the length of the secondary containment liner is also substantially greater than the length of the single-use trash bag such that even when both the single-use trash bag and secondary containment liner extend beyond the rim of the vertical chamber and are folder back along the exterior surface of the vertical chamber, the single-use trash bag ends substantially before the secondary containment liner such that removal of the single-use trash bag can readily be done independently of the secondary containment liner, such that the secondary containment liner can easily be left in place while grabbing the exposed end of the single-use trash bag to remove it from the durable trash bag container.

Optionally, the single-use trash bag may also be attached to the durable trash bag container by any other means, if desired, provided that the single-use trash bag can be independently removed from the durable trash bag container without necessarily having to remove the secondary containment liner at the same time, such that a single secondary containment liner can be used for multiple single-use trash bags, when suitable.

The durable trash bag container may comprise or be an adaptation of the containers described in U.S. Pat. No. 6,728,996, “Adjustable Liner Retainer for Containers,” which describes an adjustable liner retainer system comprising a container having an opening defining an upper edge and an outer surface and a liner situated in the container wherein an upper portion of the liner extends from the opening, folds over the upper edge, and at least partly hangs below the upper edge adjacent to the outer surface of the container. An adjustable liner retainer is tensioned around an upper end of the container pressing the hanging upper portion against the outer surface of the container. The adjustable liner retainer comprises a strip of material at least a portion of which is elastomeric material to create the tension to press the liner to the outer surface. A hook portion and a loop portion of the hook-and-loop fastener are attached to the first and second ends of the strip.

Other means for attaching the secondary containment liner to the trash bag container include the use of magnetic attachment devices (e.g., magnetic pads that are attracted to the body of the durable trash bag container such that a clamping force can be exerted against a portion of the secondary containment liner sandwiched between the magnetic pads and the body), adhesives, cohesives, clips, and mechanical fasters of all kinds. The trash containment system may be marketed with add-on clips to hold the secondary containment liner in place with a wide variety of trash bag containers.

In one embodiment, the body of a durable trash bag container comprises one or more hole therein, such as holes that are used as grips for human hands to carry the container. These holes, in one embodiment of the present invention, can serve as sockets to receive a clip or plug that can be used to secure at least one of the secondary containment liner and the single-use trash bag.

In some cases, the single-use trash bag inside the secondary containment liner may be attached to a first portion of the trash bag container, while the secondary containment liner is attached to a distinct second portion of the trash bag container. For example, the single-use trash bag may be attached to an upper portion of the trash bag container such as the inside uppermost region of a spherical dome with a pivoting door above a cylindrical body of the trash bag container, while the secondary containment liner could be attached to the top of a lower section beneath the spherical dome. For example, the attachment of the single-use trash bag to the trash bag container could be done according to the trash can system described in U.S. Pat. No. 5,957,319, “Garbage Container Cover and Liner Protector,” issued to da Costa, Sep. 28, 1999, herein incorporated by reference to the extent that it is noncontradictory herewith. Da Costa describes a trash container cover with cylindrical container having an open upper end, a closed lower end and a cylindrical side wall therebetween. A lid portion with a dome shaped configuration is secured to the open upper end of the cylindrical container. The lid portion includes at least one spherical section and a spherical opening therethrough. At least one spherical cover portion is pivotally coupled within the lid portion. The cover portion is slidably disposed within the spherical opening. The cover portion slides under the spherical section of the lid portion in an open orientation. A liner engaging portion is disposed within the spherical opening. The liner engaging portion includes a pair of strap members. One of the strap members is secured to a trailing edge of the cover portion. A second strap member is secured to an upper edge of the open upper end of the container. The strap members secure an open upper end of a trash liner with respect to the cover portion and the container whereby sliding the cover portion into the open orientation will expose the open upper end of the trash liner for receiving trash therein. Each of the strap members have free ends thereof secured to a latch for tightening of the straps for engaging the trash liner.

In cases when the single-use trash bag is attached to the trash bag container at a height greater than the attachment region for the secondary containment liner, the secondary containment liner may suitably be shorter than rather than longer than the single-use trash bag. Length is still a differentiating factor in such cases.

Examples of commercially availably trash containers include:
Witt Industries (Cincinnati, Ohio) trash cans,
United Receptacle (Pottsville, Pa.), including their Eclipse®, Silhouette®, Classics, Milan Collection, Avenue By Howard, and Americana Side Door trash cans;
Glaro trash cans, including their funnel top caps, cover tops, canopy tops, flat tops, and WasteMaster® trash cans;
Rubbermaid® trash cans, include their Glutton® hooded top, Marshal Bullet®, Torpedo®, Landmark Series Concrete, WeatherGard®, Ranger® fiberglass, Atrium Classic Containers, and the like;
Continental Trash Cans, including their flat top, drum, dolly, door mount, corner round, moon, funnel top, Wallhugger®, Huskee® dome top, Tilt N Wheel®, Huskee® square, and the like;
Commercial Zone Trash Cans, including their Hexagon, 3-Tier, Littermate®, StoneTec®, fuel island convenience center containers, and the like
Safco Trash Cans.

The trash bag container can be any known trash can or trash receptacle, such as dome lid trash cans, open top half rounds or semicircular designs, flip top containers, step-on or pedal containers, biohazard containers, dentists containers, secure document containers, ash and butt containers, etc. Trash containment systems of the present invention can be used in any suitable setting such as restaurants, public eating places, city parks, amusement parks, corporate settings such as corporate cafeterias, restrooms, offices, laboratories, industrial waste, military sites, casinos, theatres, and the like.

Materials of construction can include fiberglass, polyolefin, stainless steel, galvanized steel, wrought iron, aluminum, brass, laminates, marble, concrete, stone, etc.

In one embodiment, the trash bag container can comprise an outer body and an insert generally conforming to the shape of the outer body, providing a gap between the insert and the outer body which can engage and restrain an upper portion of the secondary containment liner. An example of such a system is described in U.S. Pat. No. 5,598,942, “Waste Basket Liner System,” issued Feb. 4, 1997 to R. Cowie. The Cowie patent describes a waste disposal bin assembly comprising an outer casing having a sidewall and an open top. A self-supporting insert member conforms to the internal shape of the sidewall and has an upper rim located below a top edge of the sidewall. A disposable bag is inserted in the insert member and has an upper portion folded over the rim of the insert member and tucked between the insert member and an inner surface of the sidewall. In this way, the disposable bag can be neatly retained within the waste disposal bin.

Other bag holding or retention systems known in the art can be adapted for the present invention, including those described in U.S. Pat. Nos. 2,140,199, “Bag Holder”; 4,124,185, “Bag Holder”; 4,338,979, “Bag Holding Device and Process”; 4,630,752, “Trash Can Hoop Retainer”; 5,261,553, “Fastening Device for Container Liners”; 5,295,606, “Trash Container”; and 5,425,468, Multi-Purpose Secretion Receptacle.”

### Garbage Bags

The single-use trash bag and the secondary containment liner can independently be constructed according to any known method for the manufacture of garbage bags. An example of a garbage bag is that disclosed in U.S. Pat. No. 5,980,109, “Self-Tied Garbage Bag,” issued Nov. 9, 1999 to Wan, herein incorporated by reference to the extent that it is noncontradictory herewith. The Wan patent describes a self-tied garbage bag that includes a pair of walls united along their lower ends and sides to form a container which has a top with an opening, a bottom and pair of lateral edges. A bond strip extends at one or both lateral edges of the container between a lower point which is spaced from the bottom of the container and an upper point which is spaced from the top of the container. The lower point of the bond strip is in the form of a sharp tip. A tear line extends along the bond strip from the lower point to a division portion which is disposal in proximity to the upper point of the bond strip. This tear line, being ruptured, separates a tie strip from the bond strip, however, integrally joining the tie-strip to the container at a division portion. The container has a wider upper part extending above the bondstrip, a wider bottom part extending below the bond strip, and a narrower middle part extending between the upper and bottom parts of the container. A bond line or tear line may be formed and extending parallel to the low line between a lower point which is spaced from the bottom of the tear line and an upper point which is spaced from the top of the tear line to reinforce the tie-strip, or to extend the bond line in a transverse direction at one end of the tear lie to double the length of the tie-strip.

As adapted for the present invention, either or both the single-use trash bag and secondary containment liner may comprise a tying mechanism such as a self-tying feature incorporated into the bag or liner.

Other garbage bag systems that can be adapted for the single-use trash bags or secondary containment liners of the present invention include those of U.S. Pat. Nos. 3,217,971; 3,664,575; 4,624,365; 5,407,419; and 5,980,109.

One or both of the single-use trash bag and secondary containment liner can comprise embossed plastic material to create texture or modified mechanical properties, including the ability to flex in response to strain, exemplified by the Glad® ForceFlex® bags marketed by Clorox (Oakland, Calif.). U.S. Pat. No. 6,139,185, “Flexible Bag with Selectively-Activatible Support-Engagement Feature,” herein incorporated by reference to the extent that it is noncontradictory herewith, discloses garbage bags that may be adapted for the present invention, wherein some of the discussed embodiments comprise a three-dimensional, conformable web comprising an active substance such as adhesive on at least one surface protected from external contact by the three-dimensional surface topography of the base material. Such materials comprise a polymeric or other sheet material which is embossed/debossed to form a pattern of raised “dimples” on at least one surface which serve as stand-offs to prevent an adhesive therebetween from contacting external surfaces until the stand-offs are deformed to render the structure more two-dimensional. Representative adhesive carrier structures include those disclosed in commonly assigned, co-pending U.S. Pat. No. 5,662,758, filed Jan. 10, 1996 in the names of Hamilton and McGuire, entitled “Composite Material Releasably Sealable to a Target Surface When Pressed Thereagainst and Method of Making,” and U.S. Pat. No. 5,965,235, filed Nov. 8, 1996 in the names of McGuire, Tweddell, and Hamilton, entitled “Three-Dimensional, Nesting-Resistant Sheet Materials and Method and Apparatus for Making Same.” For purposes of the present invention, the adhesive material may be excluded when desired, or may be selectively applied to portions of the bag for enhanced attachment to a support surface.

U.S. Pat. No. 6,602,580, “Material Having a Substance Protected by Deformable Standoffs and Method of Making,” describes three-dimensional structure that may be used in a garbage bag of the present invention, wherein the bags comprise a piece of deformable material which has a first side formed to have a plurality of hollow protrusions separated by valleys. The plurality of hollow protrusions have outermost ends. The second side has a plurality of depressions The plurality of protrusions deform by modes which are selected from the group consisting of inverting, crushing, and elongating. In the inverting and/or crushing modes of a preferred embodiment in U.S. Pat. No. 6,602,580, each of the plurality of protrusions will not substantially deform until exposed to a pressure of at least 0.1 pounds per square inch (0.69 kPa).

### ADDITIONAL EMBODIMENTS

The trash containment system of the present invention can be adapted to provide a wide degree of customization for users, and can be marketed with multiple options for selecting basis weight, absorbent material strength, size, indicia, colors, etc.

Garbage bags can also be reinforced or made of puncture resistance material to reduce the risk of puncture. For example, in dealing with medical waste, medical single-use trash bags may benefit from puncture resistant features.

In some embodiments, the absorbent material is a substantially rigid wafer having a shape similar to the cross-section of the intended body of the durable trash bag container, such that the presence of the wafer in the bottom of the secondary containment liner helps bias the secondary containment liner to fill the cross-sectional area of the body effectively and maintain a suitable shape. In such embodiments, the bag may have a better shape for stability and space utilization. The wafer, in such cases, may have dimensions that are from about 75% to 99% of from about 90 to 98% of the corresponding internal cross-sectional dimensions of the body of the durable trash bag container, by way of example.

The systems of the present invention can be adapted for use with trash compactors. This can be particularly useful for use in aircraft, ships, and other vessels or facilities that rely on trash compaction and temporary storage of waste before it can be transported to a waste disposal facility. In one version, the secondary containment liner of the present invention is used to capture excess fluid from waste in a single-use trash bag undergoing compaction, such as compaction in an aircraft or other vessel, such as the compaction systems described in U.S. Pat. No. 6,994,022, “Aircraft Trash Management System,” issued Feb. 7, 2006 to Paleschuck. Other examples of trash compactors designed for use on aircraft are described in U.S. Pat. Nos. 3,835,767, 3,835,769, 3,899,967, 4,070,962, 4,183,295, 4,444,099, 4,620,479, 4,680,808, 4,700,623, 4,719,852, 4,444,099, 4,729,303, and 5,465,660.

In some cases, the trash containment system can be incorporated in a business model with a third party such as an insurer interested in reducing accidents due to spilled liquids or spilled garbage. The insurer, for example, may provide a financial motivation to the user (e.g., a restaurant or food service business) to reduce spillage and thus the risk of slips or falls by using the trash containment system of the present invention, wherein the secondary containment liners comprise liquid absorbent materials. The user may also, in exchange, receive specialty garbage bags with suitable logos, color codes, etc., corresponding with company needs. Kits may be provided to the user comprising secondary containment liners, single-use trash bags, optional adapters for securing bags to existing durable trash bag containers or new durable trash bag containers, optional timing or tracking systems for tracking and motivating changing of secondary containment liners, and optional absorbent wafers that can be added to the secondary containment liners to increase absorbent capacity when needed (e.g., prior to peak business times). Bag usage information, including change rates, leakage rates, etc., may be obtained from the tracking systems and used to review trash management operations of the user to identify improvement in operation that can be achieved, and/or to identify products that are better customized to the needs of the user.

The system of the present invention may also be used with movable trash containers such as wheeled bins, trucks (including tilt trucks), wheel barrows, etc., or with other containers such as barrels, bins, carts, etc.

In one embodiment, the trash containment system of the present invention is used as a bio hazard bag system in which the single-use trash bag has a first color such as red and comprises antimicrobial and liquid absorbent means, such as a wafer of absorbent material such as a laminate of cellulosic products combined with antimicrobial and odor absorbent material. The single-use trash bag may be placed in a durable trash bag container and may optionally be backed by a secondary containment liner comprising an absorbent wafer that is activated by the presence of water, such that biological agents are activated that can help mitigate the risks of biohazard leakage from the single-use trash bag. When the secondary containment liner is placed within the durable trash bag container, a small amount of liquid water may be added to the wafer by spray or other means to activate the biological agents of the absorbent wafer, and thereafter a single-use trash bag may be placed inside the secondary containment liner.

In another example, the trash containment system of the present invention is used to manage odors from a pet waste system at an outdoor facility. A metal trash can with a metal lid can be used with a secondary containment liner joined to the trash can using a hoop clamp, as shown in FIG. 5, or related system. The secondary containment liner contains an absorbent wafer with odor neutralizing agents such as a two-part system. A first part comprises an absorbent substrate such as a sponge or tissue laminate impregnated with bacterial powder that is activated by water released into the absorbent wafer using a pouch of water with a frangible seal that can be squeezed to release water from the pouch into the bacterial powder to activate it. A second part may comprise zeolites, baking powder, and other substances that can absorb odors in a relatively dry state, and the materials of the second part need not be activated by application of water.

Another embodiment of the present invention includes a method of upgrading an existing trash containment system, such as the waste management systems in commercial businesses and public places. The existing trash containment system typically comprises trash bag containers having an interior portion for receiving single-use trash bags, and rely on a service agent (e.g., store employees, janitorial crew, contracted cleaners, park employees, etc.) who is responsible for replacing the single-use trash bags. The method of upgrading comprises:

a) Providing the service agent with a plurality of secondary containment liners, each secondary containment liner comprising a flexible trash liner having an open top, a closed bottom, and an internal portion, with an absorbent section adjacent the closed bottom in the internal portion of the flexible trash liner,

b) Providing instructions to the service agent to place the secondary containment liners individually to the trash bag containers, such that the secondary containment liners can receive the single-use trash bags,

c) Providing instructions to the service agent to leave the secondary containment liners in place while removing the filled single-use trash bags, unless there is substantial leakage from the single-use trash bags into a secondary containment liner or unless a predetermined time span has lapsed since placing a secondary containment liner in the trash bag containers.

The absorbent section of the secondary containment liner can include an odor inhibiting agent such as a biological odor inhibiting agent, and in some cases, such odor inhibiting agents may be activated by the application of water. In such cases, the method may further comprise:

d) Providing a source of water to moisten the odor inhibiting agent prior to or during use of the secondary containment liner;

e) Providing instructions to the service agent regarding the moistening of the odor inhibiting agent with the source of water. The instruction may include information regarding when to apply the water (e.g., when malodors are present or expected), how much to apply, how to use the applicator, etc.

Timing means such as indicia for recording dates of placement and target dates of replacement may be provided, timers, etc., may be provided as well to assist in the timing of the replacement secondary containment liners.

The method can also include providing automated or manual means for recoding placement dates of the secondary containment liner, and may include providing improved single-use trash bags (such as bags comprising absorbent material or odor inhibiting agents), improved trash bag containers, retaining means to hold a secondary containment liner in place, separably removable from the trash bag container with respect to the single-use trash bags, etc.

The distribution of secondary containment liner can be through retail outlets for use by consumers. For use in commercial facilities, distribution may be via wholesale outlets, janitorial supply services, maintenance supply centers, cleaning contractors, etc. For domestic trash collection, city or country governments or the corresponding contracted trash collection services may provide secondary containment liners to households for use in trash bins or other trash bag containers used for collection of domestic or municipal waste, thereby reducing odor, insects, etc. Attachment devices such as clamps, hoops, and the like may be used to securely attach the secondary containment liner to the trash bag container such that the secondary containment liner is not removed during domestic trash pick up (e.g., such that the secondary containment liner may remain in place when the trash bag container is seized by mechanical equipment and inverted into a garbage truck), unless the user releases the attachment to permit removal.

### EXAMPLES

### Example 1

Trash liners with a 39-gallon capacity were modified with to form secondary containment liner as shown in FIGS. 1-3, with absorbent wafers made from ZORBA® absorbent material, manufactured by JohnsonDiversey Corp. (Racine, Wis.) cut as a rectangular wafer having dimensions of about 8 inches by 10 inches, formed by gluing four smaller portions of the material together. The sides of the portions were slit with a knife to provide access to the interior, and a total of 1 gram of BEC 150 powder was injected pneumatically into the absorbent material of the ZORBA® product, using a rubber bulb to generate the puff of air to inject the powder into the fibrous center portion of the absorbent portions. The slit regions were then glued together to prevent the powder from escaping. Silicone glue was used to attach the bottom of the wafer to the bottom of the trash bag to form a secondary containment liner. Two secondary containment liners so prepared were then evaluated in field tests at commercial establishments including an outdoor food area at a mall and a convenience store.

At the mall, the mall management company provided one of their worst areas for the test: a high volume trash receptacle outside of a popular ice cream business. The trash bag container, a decorative receptacle with a hard plastic (polypropylene) tube insert was thoroughly cleaned before the test. The secondary containment liner was placed inside the clean receptacle for a 4 week test. During the first week the maintenance crew mistakenly threw out the secondary containment liner with the regular single-use trash bag during their trash run. The test was started again with a slight modification to the secondary containment liner, in that a florescent pink plastic band was adhesively attached to the mouth of the secondary containment liner to be more distinctive to employees during daily routine changes. No premature discarding of the secondary containment liner occurred after the band was installed. Regular inspect occurred during the trial period. For 18 days there was minimal seepage of trash liquids into the secondary containment liner. During a Memorial day weekend mall traffic was especially high and trash was building up in all receptacles in all areas. The maintenance crews made trash runs repeatedly throughout the day. Inspection of the secondary containment liner two days later revealed soggy debris in the bottom of the secondary containment liner, with the absorbent at roughly a 20% saturation level. No odors or insects were present. The bottom of the trash bag container remained clean and dry.

The maintenance crew at the mall indicated that the trash bag container with the secondary containment liner was the only receptacle in the mall that did not need to be cleaned. Thus, an additional benefit of the secondary containment liner system can be reduced labor costs for cleaning trash bag containers.

### Example 2

Several other absorbent materials were prepared for use in secondary containment liners.

In a first embodiment, the absorbent wafer was a ZORBA® absorbent wafer cut as a disk. A silicone glue was used to attach the absorbent wafer to the bottom of the bag. In a second series of embodiments, multiple plies of Scott® Paper Towels made by Kimberly-Clark Corp. (Dallas, Tex.) were used to form a laminate of 3 or more sheets, glued together at the periphery, with 1 gram of bacterial powder added. In a third embodiment, Kotex® pantiliners, also made by Kimberly-Clark Corp. (Dallas, Tex.), comprising a coform nonwoven web with cellulosic fibers, were used as the absorbent medium. The pantiliners were glued together in an overlapping relationship to form a composite wafer about 8 inches in width.

### REMARKS

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above compositions, products, and methods without departing from the scope of aspects of the invention, it is intended that all matter contained in the above description shall be interpreted as illustrative and not in a limiting sense.

While this invention has been described as having a preferred design, it is understood that it is capable of further modification, uses, or adaptations of the invention following in general the principle of the invention and including such departures from the present disclosures as come within the known or customary practice in the art to which the invention pertains and as may be applied to the central features hereinabove set forth, and fall within the scope of the invention and the limits of the applied claims.

We claim:

1. A trash containment system comprising a single-use trash bag, a disposable secondary containment liner, and a trash bag container, wherein the single-use trash bag is at least partially located within the secondary containment liner, and wherein the secondary containment liner comprises a plastic liner having an inner and outer surface, and further comprises a section of absorbent material in contact with the inner surface of the plastic liner, the section of absorbent material comprising a odor inhibiting agent, and wherein the secondary containment liner is at least partially located within the trash bag container.

2. The system of claim 1, wherein the absorbent material has an absorbent capacity of about 20 grams or greater, and a relative absorbent capacity of about 1 or greater.

3. The system of claim 1, wherein the absorbent material has an absorbent capacity of about 100 grams or greater, and a relative absorbent capacity of about 2 or greater.

4. The system of claim 1, wherein the odor inhibiting agent comprises a biological odor inhibiting agent.

5. The system of claim 4, wherein the biological odor inhibiting agent is a concentrated bacterial powder.

6. The method of claim 4, wherein the trash containment system further comprises a source of water associated with the secondary containment liner that can be released by a user to contact and activate the biological odor inhibiting agent.

7. The system of claim 1, wherein the odor inhibiting agent comprises one or more antimicrobial agents.

8. The system of claim 1, wherein the secondary containment liner and the single-use trash bag a readily distinguishable in appearance based on at least one of color, printed indicia, length, material characteristics, and opacity.

9. The system of claim 1, wherein the trash bag container comprises a body having an outer surface, an inner chamber with a bottom surface and an opening having a rim with a first distance separating the rim from the bottom surface of the inner chamber, wherein the secondary containment liner has a length substantially greater than the first distance, and wherein the secondary containment liner rests on the bottom surface of the inner chamber and extends beyond the rim of the body of the trash bag container and further extends a second distance from the rim along the outer surface of the trash bag container defining an outer sleeve of the secondary containment liner.

10. The system of claim 9, wherein the single-use trash bag also extends a third distance past the rim of the body along the outer surface of the trash bag container defining an outer sleeve of the single-use trash bag, wherein the third distance is substantially less than the second distance, such that the outer sleeve of the secondary containment liner is not substantially covered by the single-use trash bag.

11. The system of claim 9, wherein the single-use trash bag also extends a third distance past the rim of the body along the outer surface of the trash bag container defining an outer sleeve of the single-use trash bag, wherein the third distance is substantially greater than the second distance, such that the outer sleeve of the secondary containment liner is substantially covered by the single-use trash bag.

12. The system of claim 1, wherein the secondary containment liner is attached to the trash bag container and the single-use trash bag is substantially unattached to the trash bag container.

13. The system of claim 1, wherein the secondary containment liner and the single-use trash bag are both attached to the trash bag container by one of mechanical and adhesive means.

14. The system of claim 1, further comprising timing means to provide guidance on the target date of replacement of the secondary containment liner.

15. A method of upgrading an existing trash containment system comprising trash bag containers having an interior portion for receiving single-use trash bags, wherein a service agent is responsible for replacing the single-use trash bags, the method comprising:
a) Providing the service agent with a plurality of secondary containment liners, each secondary containment liner comprising a flexible trash liner having an open top, a closed bottom, and an internal portion, with an absorbent section adjacent the closed bottom in the internal portion of the flexible trash liner,
b) Providing instructions to the service agent to place the secondary containment liners individually to the trash bag containers, such that the secondary containment liners can receive the single-use trash bags,
c) Providing instructions to the service agent to leave the secondary containment liners in place while removing the filled single-use trash bags, unless there is substantial leakage from the single-use trash bags into a secondary containment liner or unless a predetermined time span has lapsed since placing a secondary containment liner in the trash bag containers.

16. The method of claim 15, wherein the absorbent section comprises an odor inhibiting agent.

17. The method of claim 16, wherein the absorbent section comprises a biological odor inhibiting agent.

18. The method of claim 15, further comprising:
d) Providing a source of water to moisten the odor inhibiting agent prior to or during use of the secondary containment liner;
e) Providing instructions to the service agent regarding the moistening of the odor inhibiting agent with the source of water.

19. The method of claim 15, wherein the secondary containment liner comprise a variety of sizes and colors associated with trash bag containers, the method further comprising providing instructions to the service agent regarding the selection and use of the various secondary containment liners.

20. A trash containment system comprising a trash bag container, disposable secondary containment liner adapted at least partially disposed within the trash bag container, and a single-use trash bag at least partially disposed within the secondary containment liner, wherein the secondary containment liner comprises a plastic liner having an inner and outer surface, and a section of absorbent material in contact with the inner surface of the plastic liner, the section of absorbent material comprising a liquid absorbent and an odor inhibiting agent, and wherein the secondary containment liner is at least partially located within the trash bag container.

21. A trash containment system, comprising a trash bag container, a multi-use secondary containment liner placed within the trash bag container, and a single-use trash bag placed within the secondary containment liner, the secondary containment liner having an open top and a closed bottom, an absorbent wafer located within the secondary containment liner at the bottom, the absorbent wafer being impregnated with a biological odor inhibiting agent.

22. The trash containment system of claim 21, wherein the secondary containment liner differs from the single-use trash bags in at least one of length and color.

23. The trash containment system of claim 21, wherein the absorbent wafer further comprises superabsorbent material.

24. The trash containment system of claim 21, wherein the absorbent wafer further comprises antimicrobial agents adapted to not interfere with the biological odor inhibiting agent.
